(19) United States
(12) Patent Application Publication
(10) Pub. No.: US 2009/0265643 A1
(43) Pub. Date: Oct. 22, 2009

(54) Instant messaging reception indication

(75) Inventors: Jack Jachner, Dublin, CA (US); Maybelline Mamaradlo, San Ramon, CA (US)

Correspondence Address: GARLICK, HARRISON & MARKISON (ALU), P.O. BOX 160727, AUSTIN, TX, 78716-0727, US

(73) Assignee: ALCATEL LUCENT, Paris (FR)

(21) Appl. No.: 12/105,905

(22) Filed: Apr. 18, 2008

(51) Int. Cl. G06F 15/16; G06F 3/048

(52) U.S. Cl. 715/758

(57) ABSTRACT

An instant message device provides an instant messaging reception indication by displaying an instant message sent by the instant message device, along with a visual indication of the current state of the instant message. The current state of the instant message reflects whether the instant message has been visibly displayed on the receiving device and the user is active on the device.

### BACKGROUND OF THE INVENTION

1. Technical Field of the Invention

The present invention relates in general to communication systems, and in particular, to an instant messaging communication system for transmitting instant messages.

2. Description of Related Art

Instant messaging communication systems deliver electronic text messages instantly from message senders to message recipients. For example, a text-based instant message usually appears in a pop-up window on the message recipient's computer screen essentially as soon as the message sender clicks the send button, subject to any propagation delays in the underlying transport network. Therefore, a message recipient is able to view the instant message without requiring the recipient to access an e-mail program or otherwise check for messages.

In a typical scenario, a first user (User A) initiates an instant message communication session with a second user (User B) by clicking on a “Send Instant Message” button or other similar button on User A's computer screen and identifying the message recipient (User B) for the instant message. For example, User A may access a “Buddy List” to highlight User B, and then click on a “Send Instant Message” button for User B. An instant message pop-up window then appears on User A's computer screen to allow User A to type a message to User B. When User A is finished typing the message, User A can click a “Send” button, press “Enter” or otherwise initiate transmission of the instant message to User B. When the instant message is received at User B's computer, a similar pop-window appears on User B's computer screen that includes the text message typed by User A. After User B types a response instant message to User A and clicks “Send,” the response instant message appears underneath the first instant message sent by User A in the pop-up windows on the computer screens of both User A and User B.

As Instant Messaging (IM) becomes more prevalent and used in enterprises, the current model of “best effort” for IM may become unsatisfactory to many user. For example, if the sending user does not receive a response from the receiving user, the sending user may falsely perceive that the message was delivered and displayed to the receiving user, and may assume that the lack of response is due to a conscious act by the receiving user, rather than a problem with the network, with the user's devices, or with the IM application, all of which may cause unreliable IM delivery and display. This false impression that the IM was received may lead to unnecessary delays and to unfortunate misunderstandings.

IM is often associated with presence, which gives an indication to the sending user of the presence state of the receiving user, such as on-line, away, off-line, etc. If the receiving user's presence is off-line, the IM system will typically indicate to the sending user that the “message cannot be delivered”. Although presence gives an indication of user availability, the receiving user's presence does not indicate whether the receiving user has actually received the IM. For example, the receiving user may not receive the IM if the receiving user's presence indication on the sending user's application is stale, such that the receiving user is no longer on-line (e.g. has turned off his device, or has lost network connectivity).

In addition, multiple devices used by the receiving user may cause IM delivery to devices which the user is not currently viewing. When a receiving user has multiple devices (i.e. blackberry, desktop, and laptop) that are logged onto an IM application, the IM will typically be delivered only to the active device to which the receiving user is currently on-line (e.g. whenever the user's status indicates “on-line”). If the user is not “on-line” on any device, the message will fork to all devices for which user's status specifies “away” or “out to lunch”, but not “off-line” in an attempt to reach the user. However, the receiving user may not receive the IM if the receiving user is transitioning between devices (e.g., the receiving user is leaving his desk to go mobile, and the message arrives to his desktop after he leaves, but before he becomes on-line on his mobile.)

In some cases, a receiving user may view the IM after a substantial delay, as for example after returning from being away from his desk or from being out to lunch. In that case, it would be useful to inform the sending user whether or not the receiving user, who is now on-line, has been displayed the IM or not. Therefore, what is needed is an instant messaging communication system capable of providing receipt confirmation for instant messages to indicate to a sender of an IM that the message was received and accurately displayed to the receiving user.

### SUMMARY OF THE INVENTION

Embodiments of the present invention provide an instant message device that includes an instant message client, a processor and a display. The instant message client enables a user to compose an instant message thereon, and is operable to transmit the instant message to a receiving device. The instant message client is further operable to update a current state of the instant message, in which the current state indicates whether the instant message has been visibly displayed on the receiving device. The processor executes the instant message client and is coupled to receive a confirmation message from the receiving device when the instant message is visibly displayed on the receiving device. The display is coupled to the processor for displaying the instant message and a visual indication of the current state thereof to the user.

In one embodiment, the current state is one of a sent state indicating that the instant message was sent to the receiving device or a visibly displayed state indicating that the instant message was visibly displayed on the receiving device, meaning that the instant message was not obscured from complete view on the receiving device. Upon receipt of the confirmation message indicating that the instant message was visibly displayed on the receiving device, the instant message client further operates to change the appearance of the instant message from the sent state to the visibly displayed state. In an exemplary embodiment, the visual indication of the current state is displayed as a particular font, text color or background color of the instant message.

Embodiments of the present invention further provide an instant messaging communication system including an instant message device, an instant message server and a communication network. The instant message device includes an instant message client that enables a user to compose an instant message thereon, and is operable to transmit the instant message to a receiving device and to update a current state of the instant message, in which the current state indicates whether the instant message has been visibly displayed on the receiving device. The instant message device further includes a display for displaying the instant message and a visual indication of the current state thereof to the user. The instant message server is associated with the instant message device to transmit the instant message to the receiving device. The communication network transmits the instant message between the instant message device and the instant message server.

Embodiments of the present invention additionally provide a method for providing instant messaging reception indication. The method includes creating an instant message on a sending device, sending the instant message to a receiving device and displaying both the instant message and a visual indication of the current state of the instant message on the sending device, in which the current state indicates whether the instant message has been visibly displayed on the receiving device.

### BRIEF DESCRIPTION OF THE DRAWINGS

A more complete understanding of the present invention may be obtained by reference to the following detailed description when taken in conjunction with the accompanying drawings wherein:

FIG. 1 illustrates an exemplary instant message device for use with embodiments of the present invention;

FIG. 2 illustrates an exemplary instant messaging communication system for use with embodiments of the present invention;

FIGS. 3A-3C illustrate exemplary states of an instant message displayed to a user in accordance with embodiments of the present invention;

FIG. 4 illustrates an exemplary format of instant message confirmation message, in accordance with embodiments of the present invention;

FIG. 5 is a flowchart illustrating an exemplary process for providing instant messaging reception indication, in accordance with embodiments of the present invention; and

FIG. 6 is a flowchart illustrating a more detailed exemplary process for providing instant messaging reception indication, in accordance with embodiments of the present invention.

### DETAILED DESCRIPTION OF THE DRAWINGS

FIG. 1 illustrates an exemplary instant message device 10 for use with embodiments of the present invention. The instant message device 10 is a user-operated physical communications device capable of instantly sending and/or receiving electronic text message communications over a communications network. Examples of such instant message devices 10 include, but are not limited to, a laptop computer, a personal computer, a desktop phone, a cell phone, a personal digital assistant (PDA) or other user-operated communication device.

In general, the instant message device 10 includes a processor 20, memory 30, graphical user interface (GUI) 40, display 50, input device 60 and external interface 70. The processor 20 includes one or more processors that execute instructions (e.g., applications) and the memory 30 includes one or more memories that store instructions (e.g., applications) and data used by the processor 20. As used herein, the term “processor” is generally understood to be a device that drives a general-purpose computer. It is noted, however, that other processing devices, such as microcontrollers, Field Programmable Gate Arrays (FPGAs), Application Specific Integrated Circuits (ASICs), or a combination thereof, can be used as well to achieve the benefits and advantages described herein.

For example, within the memory 30 is shown an operating system 32 and an instant message client 35 (e.g., an instant message application or software program) that include instructions executable by the processor 20. In addition, the memory 30 includes data 38 for use during execution of the instant message client 35. For example, such data 38 can include a stored instant message. To transmit and/or receive instant messages, the processor 20 accesses and runs the instant message client 35 within the memory 30. During execution of the instant message client 35, the instant message client 35 is operable to generate and transmit a text-based instant message via the processor 20. For example, the instant message client 35 can communicate with the input device 60 via the processor 20 and graphical user interface 40 to generate an outgoing instant message and communicate with the external interface 70 via the processor 20 to transmit the outgoing instant message over a communications network. In addition, the instant message client 35 is operable to receive and display incoming instant messages via the processor 20. For example, the instant message client 35 can communicate with the external interface 70 via the processor 20 to receive an incoming instant message and communicate with the display 50 via the processor 20 and graphical user interface 40 to display the received instant message.

In an exemplary embodiment, the graphical user interface 40 displays tools in the form of icons and/or text to a user of the instant message device 10 on the display 50 to enable the user to generate (compose) a text-based instant message to a message recipient and transmit that instant message to the message recipient. For example, the graphical user interface 40 may provide a “Buddy List” to the user that indicates whether a particular message recipient is on-line and available to receive instant messages, a “Send Instant Message” or other similar button that the user can click on to initiate an instant message to an identified message recipient, a textual pop-up window within which the user can type the instant message and a transmission button (e.g., “Send”, “Enter” or other button) that instructs the instant message client 35 to send the typed instant message to the identified message recipient.

The graphical user interface 40 interfaces with the input device 60 to receive instructions regarding message generation and transmission from the user and to provide such instructions to the instant message client 35. For example, the input device 60 may include one or more of a keyboard, mouse, stylus, touch screen, voice recognition application or other similar device.

In accordance with embodiments of the present invention, the instant message client 35 is further operable to provide receipt confirmation for instant messages to indicate to a sender of an IM that the message was received and displayed accurately to the receiving user. In particular, on instant message devices 10 associated with a receiving user, the instant message client 35 is operable to transmit a confirmation message to the sending instant message client when the instant message is received and visibly displayed on the receiving instant message display 50. As user herein, the term “visibly displayed” means that the entire text of the instant message is visible to the receiving user (e.g., not obscured by another window, not scrolled up beyond visibility on the receiving user GUI, etc.) and that the user is actively interacting with the device showing the text of the message on the display (e.g., by activating or manipulating input functions of the device, keypad, keyboard, mouse, stylus, touch screen, etc.).

More particularly, the receiving instant message client 35 determines: (1) that the receiving user is active (e.g., “on-line”) on the instant message device after receipt of the IM; and (2) that the entire message text was displayed so as to be visible to the receiving user on the instant message device. The receiving instant message client 35 further transmits the confirmation message to the sending instant message client. The confirmation message provides an indication to the sending instant message client of the current state of the instant message. The current state may be “visibly displayed”, as described above, or in other embodiments, the confirmation message may indicate that the current state is “received”, suggesting that the instant message was received by the receiving instant message device, but not yet visibly displayed thereon. For example, the receiving user may have their presence set to “away”, or the receiving user may have another application up which is eclipsing over the IM application window.

On instant message devices 10 associated with the sending user, the sending instant message client 35 updates the current state of any instant messages composed on the instant message device 10 and transmitted by the sending instant message client 35 to a receiving user. For example, the current state of a particular instant message may be “sent”, “received” or “visibly displayed”. The sending instant message client 35 also provides a visual indication to the sending user on the sending GUI 40 of the current state of the instant message. The receiving instant message client 35 updates the current state of an instant message based on any confirmation messages received for that instant message. For example, the receiving instant message client may send a confirmation message when the IM is received by the receiving instant message client and another confirmation message when the IM is visibly displayed. Each confirmation message includes the IM or a checksum derived from the IM that the sending instant message client can use to determine that the IM was accurately and entirely received by the receiving instant message client as composed.

Therefore, the sending instant message client 35 is able to provide visual confirmation to the sending user that the message was visibly displayed to the receiving user. Failing such confirmation, the sending user would understand that the delivery may have failed, or the receiving user did not see the arriving instant message. In a sense, it is the presence of the IM message that is displayed, e.g., “sent” then “received” and/or “displayed”, rather than the presence of the receiving user, e.g., “away” or “on-line”.

The sending instant message client 35 may use any form of visual indication to inform the sending user of the state of the IM, e.g., “sent”, “received” or “visibly displayed”. For example, the sending instant message client 35 can change the font (e.g., italic, bold or normal) of the text of the instant message, change the color of the text of the instant message, change the background color of the instant message, etc., to indicate the current state of the IM.

In an exemplary operation, the sending instant message client 35 enables a sending user to compose an instant message thereon via the GUI 40 and input device 60. The sending instant message client 35 then transmits the instant message to the desired recipient via the external interface 70 and stores a local copy of an instant message within the memory 30. In addition, the sending instant message client 35 displays the IM message content on the display 50 with a visual indication that the message is in a “sent” state. Upon receipt of the confirmation message from the receiving instant message client via the external interface 70, the sending instant message client 35 rewrites the stored copy of the IM from memory 30 to change the appearance of the IM on the display 50 from the “sent” state to the “visually displayed” state to thus inform the sending user that the instant message was visibly displayed to the receiving user. The sending instant message client 35 then discards the stored copy of the IM from the memory 30. In embodiments in which the “received” state is received in the confirmation message, the sending instant message client 35 can change the appearance of the IM on the display 50 from the “sent” state to the “received” state and maintain the local copy of the IM until the confirmation message that the IM was visibly displayed is received.

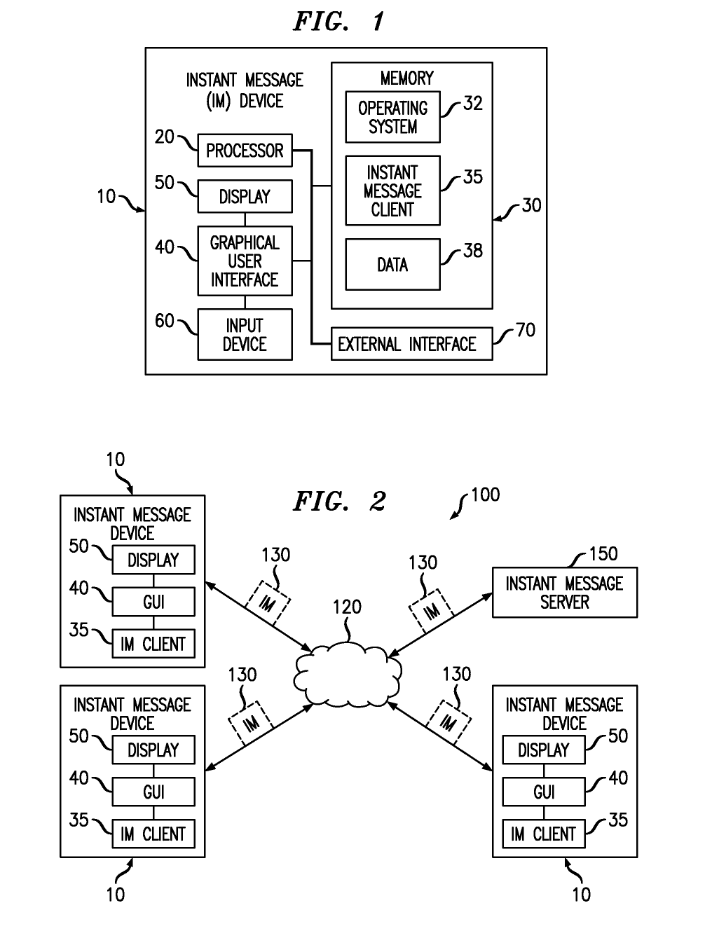

FIG. 2 illustrates an exemplary instant messaging communication system 100 for use with embodiments of the present invention. The instant messaging communication system 100 includes instant message devices 10 for generating, transmitting and receiving instant messages 130, an instant message server 150 providing an instant message service to one or more of the instant message devices 10 and a communication network 120 for routing instant messages 130 between the instant message devices 10 and the instant message server 150.

As described above, each instant message device 10 is a user-operated physical communications device capable of sending and/or receiving electronic text-based instant messages 130 over the communications network 120. Thus, each instant message device 10 includes an instant message client 35 for generating, transmitting and receiving instant messages and a GUI 40 for displaying the sent and received instant messages on a display 50 of the instant message device 10.

The message server 150 is coupled to receive instant messages 130 generated by the instant message devices 10 via the communications network 120. In addition, the message server 150 is coupled to provide the instant messages 130 to the correct instant message devices 10 (i.e., instant message recipients) via the communications network 120. For example, in exemplary embodiments, the message server 150 is a computer network server, a telephony server (e.g., a circuit switch or end office, IP router, gateway, etc.), an e-mail server, a web server or any other networked device capable of sending and/or receiving electronic text-based instant message communications over communications network 120.

In FIG. 2, the communications network 120 represents any type of network over which media (circuit-switched or packet-switched data) may be sent. For example, the communications network 120 may include one or more of the following: the Public Switched Telephone Network (PSTN), Public Land Mobile Network (PLMN), one or more private local area networks (LANs), the Internet and/or any other type or combination of networks.

In an exemplary operation, a sending user accesses one of the instant message devices 10 and initiates the instant message client 35 on his/her instant message device 10 to generate an instant message 130 to a receiving user. The sending user enters the recipient address (e.g., e-mail address of the receiving user) and a textual message stream into the instant message 130, and the instant message client 35 transmits the instant message 130 over the communications network 120. The recipient address is used by the communications network 120 to identify and locate the instant message server 150 associated with the receiving user, and to route the instant message 130 to that instant message server 150.

Upon receiving the instant message 130, the instant message server 150 may perform additional processing on the instant message 130 (e.g., filtering, automatically forwarding the instant message 130 to another instant message subscriber or another instant message device associated with the receiving user and/or converting the instant message into a format desired by the receiving user) before providing the instant message 130 to the appropriate receiving instant message device 10 (e.g., downloading the instant message 130 via communications network 120 substantially instantly to the instant message client 35 running on the receiving instant message device 10). The instant message client 35 on the receiving instant message device 10 displays the instant message to the receiving user on the display 50 of the receiving instant message device 10 via the GUI 40.

In addition, in accordance with embodiments of the present invention, the instant message server 150, in combination with the instant message client 35, may provide instant messaging reception indication to the sending user for use in determining whether the instant message was received and visibly displayed to the receiving user. For example, the instant message server 150 in conjunction with the instant message client 35 may enable the receiving instant message device 10 to generate and transmit a confirmation message to the sending instant message device 10 to provide confirmation of the reception and display of the instant message on the receiving instant message device to the sending instant message device 10. The sending instant message client 35 may further provide a visual confirmation to the sending user on the sending GUI 40 that the message was visibly displayed to the receiving user.

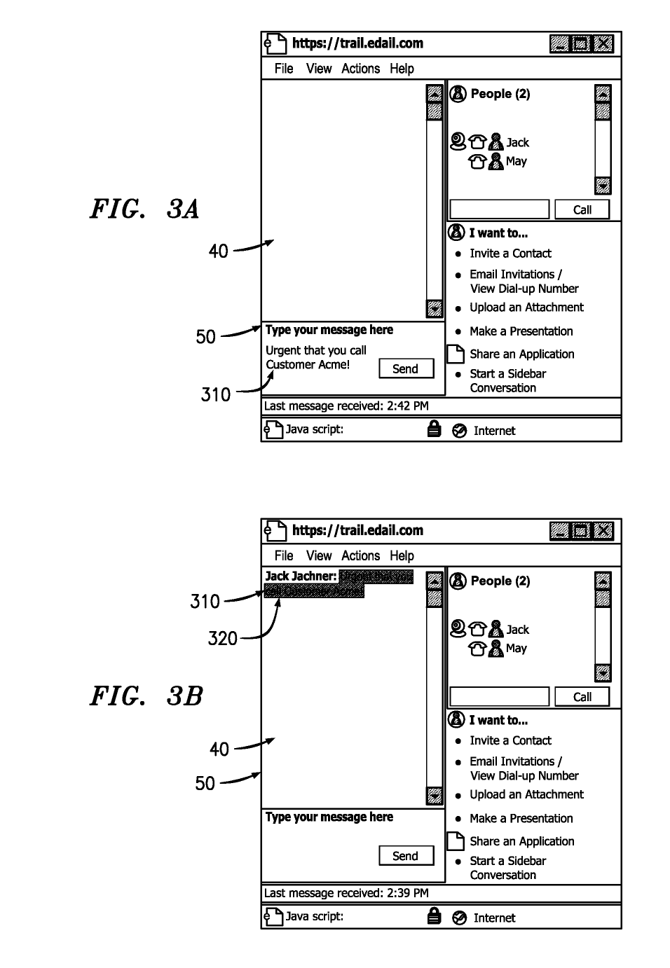

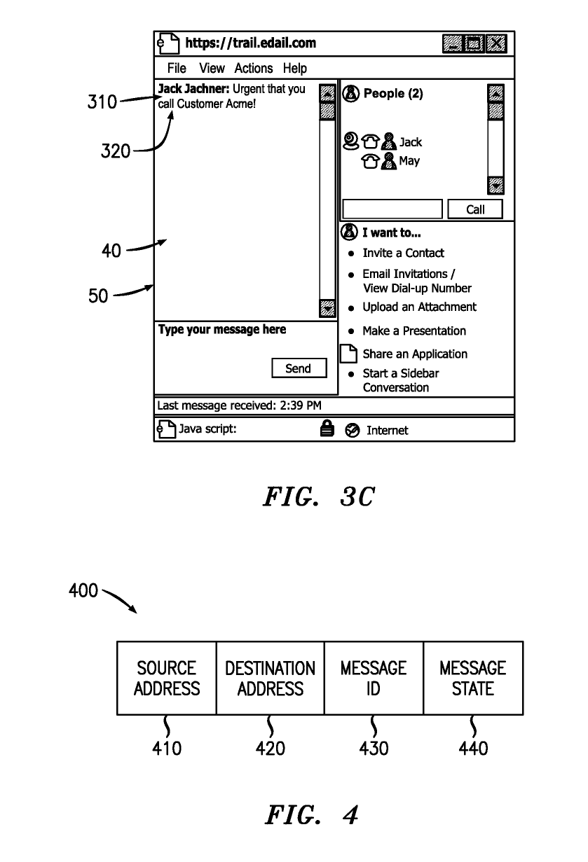

Turning now to FIGS. 3A-3C, an exemplary visual indication of the current state of an instant message is illustrated. In FIG. 3A, a sending user is composing an instant message 310 within a text input window of a GUI 40 on a display 50. Once the message has been composed, and the sending user has clicked the “Send” button on the GUI 40, as shown in FIG. 3B, the text of the instant message 310 is displayed within another window of the GUI 40. The text of the instant message 310 in FIG. 3B is highlighted, as indicated by reference number 320a, to denote that the current state of the instant message is the “sent” state, which provides a visual confirmation to the sending user that the instant message has been sent to the receiving user. In FIG. 3C, the appearance of the text of the instant message 310 has changed to no longer be highlighted, as indicated by reference number 320b, to denote that the current state of the instant message is now the “visibly displayed” state, which provides a visual confirmation to the sending user that the instant message has been visibly displayed to the receiving user.

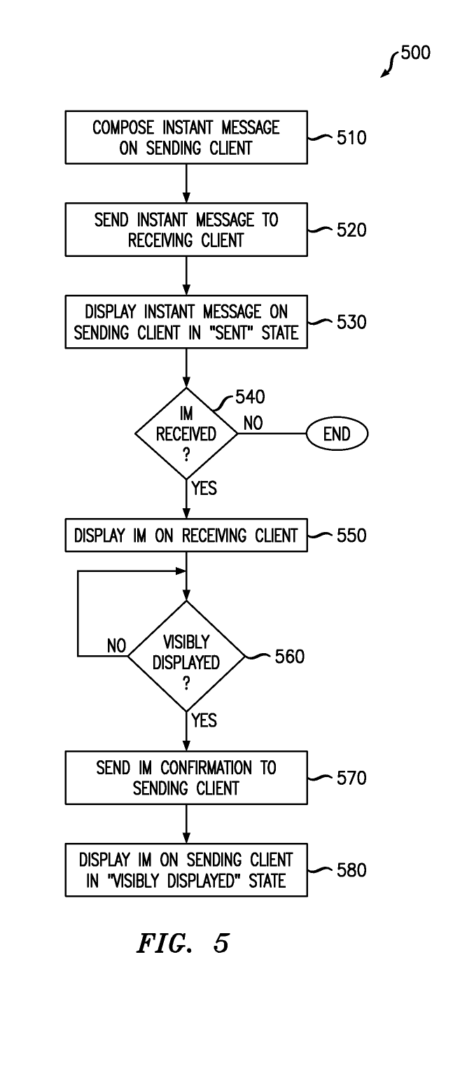

FIG. 4 illustrates an exemplary format of a confirmation message, in accordance with embodiments of the present invention. As shown, the exemplary confirmation message 400 includes a source address field 410, a destination address field 420, a message identifier field 430 and a message state field 440. The source address field 410 includes the address (e.g., IP address or e-mail address) of the receiving user that received the instant message and originated the confirmation message and the destination address field 420 includes the address (e.g., IP address or e-mail address) of the sending user that sent the instant message.

The message identifier field 430 includes any type of information that can be used by the sending instant message client to determine the message number and/or content of the instant message associated with the confirmation message. For example, the message identifier field 430 may include either the entire original IM or a checksum derived from the IM content that uniquely identifies the message number and content. The message state field 440 includes an indicator identifying the current state of the instant message at the receiving instant message client. For example, the message state field 440 may indicate that the current state of the instant message is either “received” or “visibly displayed.”

FIG. 5 is a flowchart illustrating an exemplary process 500 for providing instant messaging reception indication, in accordance with embodiments of the present invention. At block 510, the sending user composes the IM on the sending instant message client. At block 520, the sending instant message client sends the IM to the receiving instant message client directly or via the IM Server or other IM Service, and stores a local copy. At block 530, the sending instant message client displays the IM message content with a visual indication that the message is in a “sent” state. Thereafter, at block 540, a determination of whether the IM is received by the receiving instant message client is made.

If the receiving instant message client fails to receive the IM, the message display on the sending instant message client never progresses past the “sent” state, and the process ends. However, if the receiving instant message client running on any receiving instant message device receives the IM, then at block 550, the receiving instant message client stores the IM and displays the IM on the GUI of the receiving instant message device. If, at block 560, the receiving user is active on the receiving user device after the message is visibly displayed and the text of the message is not obscured, then at block 570, the receiving instant message client sends to the sending instant message client a confirmation that the IM that was visibly displayed and the receiving instant message client may then discard the stored copy.

However, if at block 560, the instant message is not visibly displayed to the receiving user, the message display on the sending instant message client never progresses past the “sent” state (unless a “received” state is also used). Upon receipt of the confirmation message, at block 580, the sending instant message client rewrites the stored copy of the IM from memory to change the appearance of the text of the instant message from the “sent” state to the “visually displayed” state to thus inform the sending user that the instant message was visibly displayed to the receiving user, and the sending instant message client then discards the stored copy.

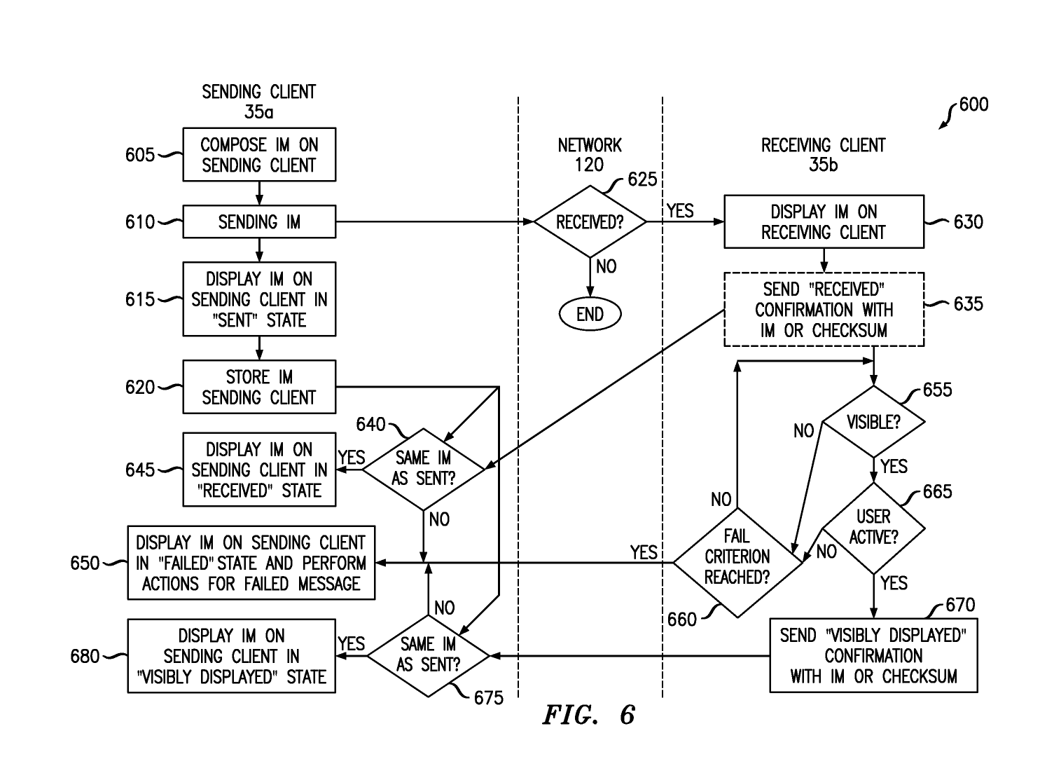

FIG. 6 is a flowchart illustrating a more detailed exemplary process 600 for providing instant messaging reception indication, in accordance with embodiments of the present invention. In FIG. 6, the flow between and actions of the sending instant message client 35a and the receiving instant message client 35b are separated to more clearly illustrate the exemplary process. At the sending instant message client 35a, in block 605, the sending user composes the IM, and at block 610, the sending instant message client 35a sends the IM to the receiving instant message client 35b via network 120. At block 615, the sending instant message client 35a displays the IM message content with a visual indication that the message is in a “sent” state, and at block 620, stores a local copy of the IM.

Thereafter, at block 625, a determination of whether the IM is transmitted through the network 120 to the receiving instant message client 35b is made. If not, the process ends, and the message display on the sending instant message client never progresses past the “sent” state. However, if a receiving instant message client 35b running on any receiving instant message device receives the IM, then at block 630, the receiving instant message client stores the IM and displays the IM on the GUI of the receiving instant message device. Optionally, at block 635, the receiving instant message client 35b can send to the sending instant message client 35a a confirmation message that the IM that was received. The confirmation message includes the IM content (text of the IM) or a checksum derived from the IM content. At block 640, the sending instant message client 35a determines whether the received IM is the same as the sent IM by comparing the IM content or checksum with the stored IM. If so, at block 645, the sending instant message client 35a rewrites the stored copy of the IM from memory to change the appearance of the text of the instant message from the “sent” state to the “received” state to thus inform the sending user that the instant message was received by the receiving user. If not, at block 650, the sending instant message client 35a rewrites the stored copy of the IM from memory to change the appearance of the text of the instant message from the “sent” state to the “failed” state and performs actions for the failed IM.

On the receiving instant message client 35b, if, at block 655, the instant message is visibly displayed on the receiving user device, and at block 665, the receiving user is active on the receiving user device after the message is visibly displayed, then at block 670, the receiving instant message client 35b sends to the sending instant message client 35a another confirmation message that the IM that was visibly displayed. Again, the confirmation message includes the IM content (text of the IM) or a checksum derived from the IM content. At block 675, the sending instant message client 35a determines whether the received IM is the same as the sent IM by comparing the IM content or checksum with the stored IM. If so, at block 680, the sending instant message client 35a rewrites the stored copy of the IM from memory to change the appearance of the text of the instant message from the “sent” state to the “visibly displayed” state to thus inform the sending user that the instant message was received by the receiving user. If not, at block 650, the sending instant message client 35a rewrites the stored copy of the IM from memory to change the appearance of the text of the instant message from the “sent” state to the “failed” state and performs actions for the failed IM.

However, if at blocks 655 and 665, the instant message is not visibly displayed to on a receiving device or the IM is visibly displayed, but on a receiving device that the receiving user is not active on after the IM is visibly displayed, a determination is made at block 660 whether fail criterion for the IM have been reached. If not, the process returns to block 655, where the receiving instant message client 35b continues to monitor the state of the received IM to determine whether it is both visibly displayed on a receiving device and visibly displayed on a receiving device on which the receiving user is active after the display thereof. If fail criterion for the IM have been reached, at block 650, the receiving instant message client 35b informs the sending instant message client 35a of the failure and the sending instant message client 35a rewrites the stored copy of the IM from memory to change the appearance of the text of the instant message from the “sent” state to the “failed” state.

As will be recognized by those skilled in the art, the innovative concepts described in the present application can be modified and varied over a wide rage of applications. Accordingly, the scope of patents subject matter should not be limited to any of the specific exemplary teachings discussed, but is instead defined by the following claims.

We claim:

1. An instant message device, comprising:
an instant message client operable to enable a user to compose an instant message, and further operable to transmit said instant message to a receiving device and update a current state of said instant message, said current state indicating whether said instant message has been visibly displayed on the receiving device;
a processor for executing said instant message client and coupled to receive a confirmation message from the receiving device when said instant message is visibly displayed on the receiving device; and
a display coupled to said processor for displaying said instant message and a visual indication of said current state thereof to the user.

2. The device of claim 1, wherein said current state is one of a sent state indicating said instant message was sent to the receiving device or a visibly displayed state indicating said instant message was visibly displayed on the receiving device such that said instant message was not obscured from complete view on the receiving device while a receiving user is active on the receiving device.

3. The device of claim 2, further comprising:
a memory for storing said instant message, said processor operating said instant message client to retrieve said instant message from said memory, rewrite said instant message on said display to change an appearance of said instant message from said sent state to said visibly displayed state and delete said instant message from said memory upon receipt of said confirmation message.

4. The device of claim 3, wherein said current state further includes a received state indicating said instant message was received by the receiving device but not yet visibly displayed thereon, said confirmation message including either said received state or said visibly displayed state, said processor operating said instant message client to change said appearance of said instant message from said sent state to said received state and to maintain said instant message in said memory upon receipt of said received state within said confirmation message.

5. The device of claim 4, wherein said current state further includes a failed state indicating said instant message failed to be visibly displayed on the receiving device, said confirmation message including said received state, said visibly displayed state or said failed state, said processor operating said instant message client to initiate one or more pre-defined actions upon receipt of said failed state.

6. The device of claim 5, further comprising:
a graphical user interface coupled between said processor and said display for displaying said instant message and said visual indication of said current state thereof on said display.

7. The device of claim 6, wherein said graphical user interface is further operable to display said visual indication of said current state as a particular font, text color or background color of said instant message.

8. The device of claim 6, further comprising:
at least one input device coupled to said graphical user interface and manipulated by the user to compose said instant message.

9. The device of claim 1, wherein said instant message has a message identifier associated therewith, said confirmation message including said message identifier to enable said processor to identify said instant message associated with said confirmation message.

10. The device of claim 9, wherein said message identifier includes said instant message or a checksum derived from said instant message that uniquely identifies said instant message.

11. An instant messaging communication system, comprising:
an instant message device including:
a sending instant message client operable to enable a user to compose an instant message, and further operable to transmit said instant message to a receiving device and update a current state of said instant message, said current state indicating whether said instant message has been visibly displayed on the receiving device, and
a display for displaying said instant message and a visual indication of said current state thereof to the user;
an instant message server coupled to transmit said instant message to the receiving device; and
a communication network over which said instant message is transmitted between said instant message device and said instant message server.

12. The system of claim 11, wherein said current state is one of a sent state indicating said instant message was sent to the receiving device or a visibly displayed state indicating said instant message was visibly displayed on the receiving device such that said instant message was not obscured from complete view on the receiving device while a receiving user is active on the receiving device.

13. The system of claim 12, wherein said instant message device further includes a memory for storing said instant message, said instant message client operating to retrieve said instant message from said memory, rewrite said instant message on said display to change an appearance of said instant message from said sent state to said visibly displayed state and delete said instant message from said memory upon receipt of said confirmation message.

14. The system of claim 13, wherein said current state further includes a received state indicating said instant message was received by the receiving device but not yet visibly displayed thereon, said confirmation message including either said received state or said visibly displayed state, said instant message client operating to change said appearance of said instant message from said sent state to said received state and to maintain said instant message in said memory upon receipt of said received state within said confirmation message

15. The system of claim 14, further comprising:
an additional instant message device coupled to said communication network, said additional instant message device being the receiving device and including:
a receiving instant message client coupled to receive said instant message from said sending instant message client and to transmit a confirmation message to said sending instant message client, said confirmation message including said received state or said visibly displayed state, and
a display for displaying said instant message thereon.

16. The system of claim 15, wherein said instant message has a message identifier associated therewith, said confirmation message including said message identifier to enable said sending instant message client to identify said instant message associated with said confirmation message.

17. The system of claim 16, wherein said message identifier includes said instant message or a checksum derived by said receiving instant message client from said instant message that uniquely identifies said instant message.

18. A method for providing instant messaging reception indication, comprising:
creating an instant message on a sending device;
sending said instant message to a receiving device; and
displaying said instant message and a visual indication of a current state of said instant message on said sending device, said current state indicating whether said instant message has been visibly displayed on the receiving device.

19. The method of claim 18, further comprising:
receiving a confirmation message from the receiving device when said instant message is visibly displayed on the receiving device; and
updating said visual indication of said current state of said instant message on said sending device to indicate said instant message has been visibly displayed on the receiving device.

20. The method of claim 19, wherein said current state is one of a sent state indicating said instant message was sent to the receiving device or a visibly displayed state indicating said instant message was visibly displayed on the receiving device such that said instant message was not obscured from complete view on the receiving device, and wherein said updating further includes:
rewriting said instant message on said sending device to change an appearance of said instant message from said sent state to said visibly displayed state upon receipt of said confirmation message.
